(19) United States
(12) Patent Application Publication
(10) Pub. No.: US 2025/0127374 A1
(43) Pub. Date: Apr. 24, 2025

(54) WATER-CARRYING HOUSEHOLD APPLIANCE WITH A DETERGENT DOSING DEVICE

(71) Applicant: V-ZUG AG, Zug (CH)

(72) Inventors: Ingo Gau, Oberwil (CH); Etienne Lardon, Hünenberg See (CH); Daniel Muff, LUZERN (CH)

(21) Appl. No.: 18/828,372

(22) Filed: Sep. 9, 2024

(30) Foreign Application Priority Data
Oct. 18, 2023 (CH) CH001152/2023

(51) Int. Cl. A47L 15/44; B65D 65/46; B65D 75/36; D06F 39/02

(52) U.S. Cl. CPC A47L 15/4463; A47L 15/4436; B65D 65/46; B65D 75/367; D06F 39/026

(57) ABSTRACT

The invention relates to a water-carrying household appliance, in particular a dishwasher or a washing machine. The household appliance comprises a tub in which items to be cleaned can be arranged for cleaning, a detergent unit with a detergent reservoir and a detergent supply unit for supplying detergent from the detergent reservoir into the tub. The detergent reservoir is configured to hold detergent in the form of a solid. The detergent supply unit comprises a separating device for partially separating detergent from the solid detergent held in the detergent reservoir. The detergent reservoir is configured to hold detergent for at least two cleaning processes.

### FIELD OF THE INVENTION

The invention relates to a water-carrying household appliance, in particular a dishwasher or a washing machine. The household appliance comprises a tub, in which items to be cleaned can be arranged for cleaning, and a detergent unit. The detergent unit comprises a detergent reservoir, which is configured to hold detergent in the form of a solid. In addition, the detergent unit comprises a detergent supply unit, which is used to supply detergent from the detergent reservoir to the tub. The detergent supply unit comprises a separating device for partially separating detergent from the solid detergent held in the detergent reservoir.

### BACKGROUND

In dishwashers commonly used in private households, the user positions a detergent tablet in a storage compartment before starting a dishwashing program. A few minutes after the start of the dishwashing program, the compartment opens and the detergent tablet falls into the water collected in the tub. The detergent tablet is dissolved by the water and develops its cleaning effect via the process water. The user must insert such a detergent tablet into the dispenser compartment each time before starting a dishwashing program.

In commercial dishwashers, it is common for the dishwasher to be connected to a detergent tank in which liquid detergent is stored. The liquid detergent is automatically added to the process water. Such detergent tanks require a corresponding amount of space, but are practical in commercial use because the detergent tank rarely needs to be replaced.

### DISCLOSURE OF THE INVENTION

The problem to be solved by the present invention is to provide a water-carrying household appliance which is convenient to operate with respect to the supply of detergent.

This problem is solved by the subject of the independent claim. This is a water-carrying household appliance, in particular a dishwasher or a washing machine. The household appliance comprises a tub in which items to be cleaned can be arranged for cleaning. In a dishwasher, there are crockery baskets in which the crockery is stored. In a washing machine, a rotatable drum is arranged in the tub in which laundry can be washed.

The water-carrying household appliance comprises a detergent unit with a detergent reservoir and a detergent supply unit. The detergent reservoir is configured to hold detergent in the form of a solid. In the case of a dishwasher, this is usually referred to as dishwashing detergent, and in the case of a washing machine as washing detergent. Both dishwashing detergent and laundry detergent fall under the term “detergent”.

In particular, “form of a solid” means that the dishwashing detergent is a single solid or has individual, physically coherent solids with a volume of at least 0.1 cm³, in particular at least 0.2 cm³, in particular at least 0.5 cm³, in particular at least 1 cm³, in particular at least 2 cm³. In other words, purely powdered detergent would not be included. However, powdered detergent can be compressed into a solid.

The detergent supply unit is used to feed the detergent from the detergent reservoir into the tub. It comprises a separating device which serves to partially separate the detergent from the solid detergent held in the detergent reservoir. The separating device can be a mechanical separation process. In particular, the detergent supply unit can flush the separated detergent into the tub using process water.

In addition, the detergent reservoir can hold detergent for at least two cleaning processes. This means that the user is not forced to add detergent to the household appliance before each individual cleaning process. This allows convenient operation of the household appliance, particularly in the home.

Advantageously, the separating device is configured to separate detergent by means of a machining process, in particular by means of grating, planing, shearing or cutting. In other words, the separation takes place mechanically by means of a separation process. Such a separating device is inexpensive to manufacture and works reliably.

In particular, the separating device is moved along the detergent in the detergent reservoir. This means, for example, that a grater is moved back and forth along the detergent so that some of the detergent is rubbed off. Alternatively, the detergent is moved instead of the separating device.

The detergent or the separating devices can be moved by means of a linear movement or a rotational movement.

Advantageously, the detergent supply unit is configured to convey the separated detergent into the tub by means of process water. This reliably flushes the separated detergent into the tub.

In particular, the detergent supply unit is configured to feed the detergent in the detergent reservoir to the separating device, especially by means of a spring force, a screw movement, a linear motor, by means of a rotary wheel or by means of a feed nut running on a spindle. This allows the separation process to be continued continuously until the detergent in the detergent reservoir is completely used up.

The separating device is advantageously configured to seal the detergent reservoir vapor-tight against the tub. As the detergent is bound in a solid, it must be protected from splashing water or the effects of vapor. Otherwise, the detergent would dissolve and could no longer be used in a targeted manner.

In particular, the detergent reservoir is configured to hold a single, in particular rod-shaped or plate-shaped detergent strand, whereby the detergent strand has a length that is at least three times as great as its smallest width. This allows the detergent to be separated in relatively small units and dosed into the tub in a targeted manner, while at the same time allowing a large quantity of detergent to be stored in the detergent reservoir.

Advantageously, the detergent reservoir is configured to hold a stack of detergent tablets, and the separating device is configured to individually transport detergent tablets from the stack into the tub, in particular by means of a sliding movement from the stack or by shearing off stuck tablets. This form of separation is technically simple and inexpensive to implement. In addition, the separation is reliable as no separation process is used. The detergent tablets are already pre-portioned and one detergent tablet after the other can be added to the tub, depending on how much detergent is required. The smaller the individual detergent tablets are, the more precise the dosing can be.

In particular, the detergent reservoir is configured to hold several detergent tablets, which are packed in a common packaging, in particular plastic packaging. The packaging protects the user when inserting the detergent tablets into the detergent reservoir. However, the common packaging makes it much easier to insert a large quantity of detergent tablets into the detergent reservoir.

In particular, the separation unit is configured to separate the detergent tablets individually from the packaging, in particular to press them out of the packaging or to cut out the detergent tablets together with the packaging. This allows individual detergent tablets to be dosed into the tub from the common packaging. If more detergent is required, several detergent tablets can be added one after the other.

In particular, the packaging comprises several vapor-tightly sealed chambers and a single one of the several detergent tablets is arranged in each individual chamber. This has the advantage that after a single detergent tablet has been squeezed out of the common packaging, the remaining detergent tablets continue to be arranged in a vapor-tight manner in separate chambers of the packaging.

Advantageously, the packaging is water-soluble or vapor-tight. If the packaging is water-soluble, it can be conveyed into the tub together with the detergent tablet and is dissolved. No packaging waste needs to be disposed of. If, on the other hand, the packaging is vapor-tight, there is no risk of vapor rising from the tub into the detergent reservoir, dissolving the packaging and causing dosing problems.

The separating unit is advantageously configured to dispense at least two detergent tablets into the tub during a single cleaning process. Although the detergent tablets are individually packaged, it is possible to separate several detergent tablets from the packaging during a cleaning process. The same applies if the detergent tablets are removed from a stack. Several detergent tablets can be separated from the stack per cleaning process.

In a particular embodiment, the detergent supply unit, in particular the separating device, is configured to seal the detergent reservoir from the tub in a vapor-tight manner. This is necessary because otherwise vapor can flow from the tub into the detergent reservoir and dissolve or destroy the detergent.

In particular, the detergent supply unit can be configured in such a way that during the transport of the separated, individual detergent tablets, these are transported upwards, at least in sections, in order to reduce or prevent the transfer of vapor from the tub to the detergent reservoir. This is because the vapor would have to flow downwards in order to move in the opposite direction from the tub to the detergent reservoir, but this does not happen as the hot vapor only flows upwards.

Advantageously, the detergent supply unit comprises a siphon which is arranged and configured in such a way that it reduces or prevents the transfer of vapor from the tub to the detergent reservoir.

In particular, the detergent supply unit comprises a sluice system with a sluice chamber for preventing or reducing vapor transfer from the tub to the detergent reservoir. In particular, the sluice system comprises a drying device for drying the sluice chamber.

In particular, the detergent supply unit comprises a sealing slide, an iris diaphragm or a silicone seal to prevent or reduce vapor transfer from the tub to the detergent reservoir.

### BRIEF DESCRIPTION OF THE DRAWINGS

Further embodiments, advantages and applications of the invention are shown in the dependent claims and in the following description with reference to the figures. The figures show

FIG. 1 a dishwasher with a tub;

FIG. 2 a detergent reservoir and a detergent supply unit according to a first embodiment;

FIG. 3 a detergent reservoir and a detergent supply unit according to a second embodiment; and

FIG. 4 a detergent reservoir and a detergent supply unit according to a third embodiment.

### WAYS OF CARRYING OUT THE INVENTION

The invention is illustrated by means of a dishwasher. However, a person skilled in the art is easily able to implement the same invention in a washing machine.

FIG. 1 shows a household dishwasher with a tub 1. Three crockery baskets are arranged inside the tub 1, a lower basket 2a, an upper basket 2b and a cutlery drawer 2c. Crockery corresponding to the items to be cleaned is arranged in the crockery baskets. In addition, various spraying means 3 are provided in the tub 1, such as a lower spraying means 3a and a middle spraying means 3b in the form of spray arms and an upper spraying means 3c, to spray or pressurize the items to be cleaned with process water. A circulation pump 4 is used to convey the process water from a base area 5 of the tub 1 to the spraying means 3 via a circulation line. A heating device 6 is provided on the circulation line to heat the process water to a desired temperature.

The appliance also has a drain pump 7, with which process water that is no longer required can be pumped out of the base area 5 of the tub 1, as well as a process water supply 8 to supply process water to the household dishwasher.

The various actuators of the appliance, in particular the pumps 4 and 7 and the heating device 6, are controlled by a control unit 9a of the appliance. Input and output means 10 are connected to the control unit 9a, via which the user can issue commands to the dishwasher and obtain information from the dishwasher. The control unit 9 comprises different cleaning programs for operating the dishwasher. It comprises at least one normal program, a pre-rinse program and an eco-program and can access data records in a data memory 9b.

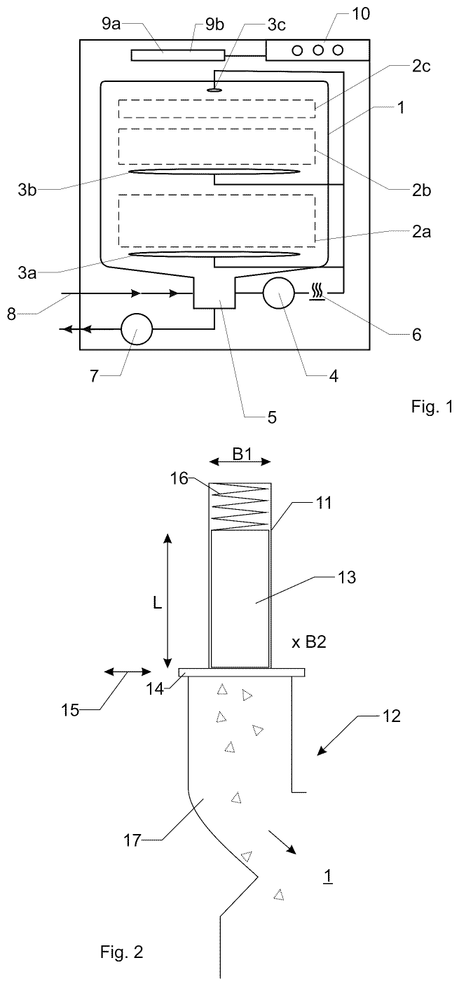

FIG. 2 shows a first embodiment of the invention. Detergent is arranged in the form of a detergent strand 13 in a detergent reservoir 11. The detergent strand 13 has a first width B1 of 3 cm, a second width B2 of 3 cm and a length L of 25 cm. In FIG. 2, the width B2 corresponds to the depth of the detergent line 13, i.e. the width B2 extends into FIG. 2. The smallest width is 3 cm. The detergent strand 13 is an elongated solid. Alternatively, the detergent strand could also be configured as a hexagonal rod or a plate.

A grater 14 is arranged at the lower end of the detergent reservoir 11, which serves as a separating device. The grater 14 separates detergent from the detergent strand 13. An electric motor moves the grater 14 back and forth in the direction of the double arrow 15 by means of a linear movement. Alternatively, the grater 14 could also be disc-shaped or drum-shaped and rub detergent off the detergent line 13 by means of a rotary movement. In a further alternative embodiment, the grater 14 could be stationary and an electric motor could move the detergent strand 13 along the grater 14.

Furthermore, a spring 16 is present in the detergent reservoir 11, which tracks the detergent strand 13 or presses it against the grater 14. This ensures that detergent is always rubbed off during a movement 15 of the grater 14 as long as the detergent strand 13 is not completely used up. Once the detergent strand 13 is completely worn down, the user can insert a new detergent strand 13 into the detergent reservoir 11. Alternatively, a new detergent strand can be placed on a small remnant of a detergent strand.

Once the rubbing of detergent is complete, the grater 14 can move to a position in which the grater 14 forms a physical barrier between the detergent reservoir 11 and the tub 1. This prevents vapor from flowing from the tub 1 to the detergent line 13 and inadvertently dissolving the detergent. In other words, the separating device configured as a grater 14 is suitable for sealing the detergent reservoir 11 from the tub 1 in a vapor-tight manner.

The chips, which the grater 14 has separated from the detergent strand 13, fall downwards into a channel 17 and slide further into the tub 1. The grater 14 and the channel 17 form the detergent supply unit 12.

The detergent reservoir 11 and the detergent supply unit 12 are not shown in FIG. 1. Preferably, the device according to FIG. 2 is arranged in the door of the dishwasher.

The described embodiment has the advantage that, depending on the requirements of the dishwashing program or the cleaning process, any desired amount of detergent can be rubbed off the detergent line 13 and dispensed into the tub 1. In addition, a detergent line 13 contains more detergent in terms of quantity than is required during a single detergent program. Accordingly, detergent can be provided for several subsequent dishwashing programs with a single detergent strand 13.

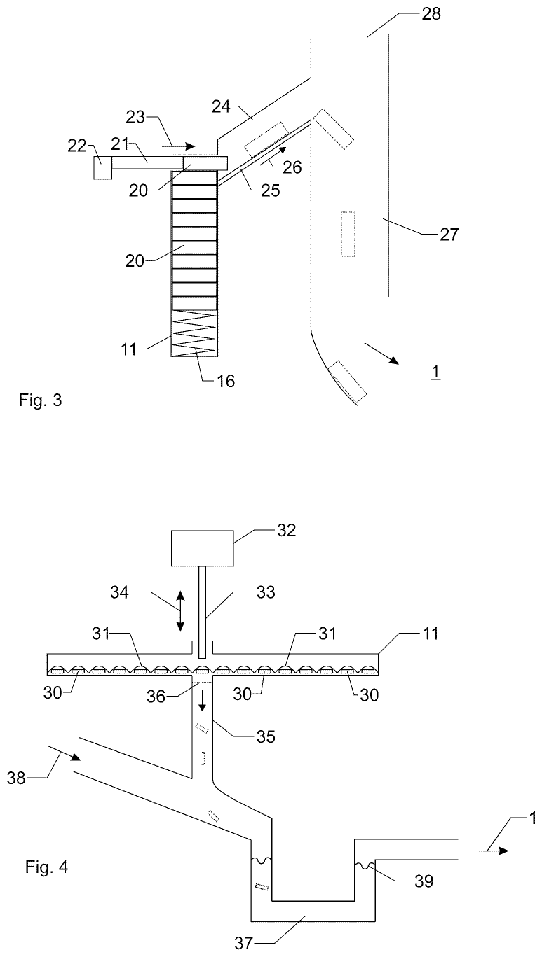

FIG. 3 shows a second embodiment of the invention. A stack of detergent tablets 20 is arranged in the detergent reservoir 11. A single detergent tablet 20 has the exemplary dimensions of 1.5 cm in diameter and 0.6 cm in height. Depending on the requirements of the dishwashing program, the dosage of a single detergent tablet 20 is sufficient, but under certain circumstances two or more detergent tablets 20 must be dosed into the tub for a single dishwashing program. The detergent tablets 20 can be unpackaged, individually packaged or stacked together in the detergent reservoir.

A pushing device 21, which is driven by an electric motor 22 and pushes detergent tablets 20 individually in the direction of arrow 23 into an upwardly directed channel 24, is arranged at the upper end of the detergent reservoir. If the detergent tablets 20 are packed in stacks in a common package, the pushing device 21 pushes an individual detergent tablet 20 out of the common package. The pushing device 21 represents the sophisticated separating device.

In an alternative embodiment, the individual tablets are glued together to form a stack. The pushing device thereby shears the individual washing-up liquid tablets from the stack, i.e. the glued joint represents a predetermined breaking point, whereby the shear strength at the gluing point must be overcome. Alternatively, a detergent strand can also be provided, which has a plurality of notches and the notches represent a predetermined breaking point for shearing off individual sections of the detergent strand.

A conveying device 25 is arranged in the upwardly orientated channel 24, which conveys the detergent tablets 20 upwards in the direction of arrow 26 into the vertically directed channel 27. Within the vertically directed channel 27, the detergent tablets 20 fall downwards into the tub 1.

The upwardly directed channel 24 has the advantage that vapor which escapes from the tub 1 through the vertically oriented channel 27 flows upwards through the vent opening 28 and not to the detergent reservoir 11. This prevents moisture from dissolving the detergent in the detergent reservoir 11.

A spring 16 is arranged inside the detergent reservoir 11, which pushes the detergent tablets 20 of the stack upwards. Once all the detergent tablets 20 have been used up, the user can refill the detergent reservoir 11 with a new stack of detergent tablets 20.

The pushing device 21, the upwardly orientated channel 24 and the vertically orientated channel 27 together form the detergent supply unit.

FIG. 4 shows a third embodiment of the invention. A plurality of detergent tablets 30 are arranged in a common plastic package 31 in the detergent reservoir 11. The detergent tablets 30 all have the same size. For example, a detergent tablet 30 has a size as already described in the second embodiment.

In addition, a separating device is provided which is suitable for separating detergent tablets 30 from the detergent reservoir 11 or from the plastic packaging 31. An electric motor 32 moves a plunger 33 in a vertical direction in accordance with the double arrow 34. With a downward movement, the plunger 33 presses the detergent tablet 30, which is arranged in the center above a vertically extending channel 35, individually out of the plastic packaging 31.

Inside the plastic packaging 31, the detergent tablets 30 are arranged individually in separate chambers of the plastic packaging 31. The chamber system of the plastic packaging 31 ensures that the individual detergent tablets 30 are mutually sealed in a vapor-tight manner. If the plunger 33 presses a detergent tablet 30 out of the plastic packaging 31, the remaining detergent tablets 30 are still sealed vapor-tight in their chambers of the plastic packaging. This prevents vapor from rising from the tub 1 to the detergent reservoir 11 and dissolving the detergent tablets 30.

During a cleaning process, i.e. during a single dishwashing program, only a single detergent tablet 31 or even several detergent tablets 30 can be dispensed from the plastic packaging 31 into the tub 1.

Alternatively, the plastic packaging 31 can be configured to be water-soluble rather than vapor-tight. In this case, the tub 1 must be sealed off from the detergent reservoir 11 in a vapor-tight manner by means of a physical barrier, e.g. by means of a closure 36 in the vertically running channel 35 or by means of a siphon 37. In FIG. 4, the closure 36 and the siphon 37 are shown as alternative seals. To operate the siphon 37, process water must be flushed into the siphon 37 via a process water supply 38. The process water 38 flushes the detergent tablets 30 through the siphon 37 into the tub 1. The siphon 37 is configured in such a way that there is always a water level 39 in the siphon 37. The water in the siphon 37 prevents moisture from reaching the detergent reservoir 11 from the tub 1 and dissolving the detergent.

However, a water-soluble plastic packaging 31 has the advantage that any pieces of plastic squeezed out of the plastic packaging 31 or the entire packaging may get into the tub 1 and be dissolved there by the water. The plunger 33 and the vertically extending channel 35 together form the detergent supply unit.

Whilst preferred embodiments of the invention are described in the present application, it should be clearly noted that the invention is not limited to these and may also be carried out in other ways within the scope of the following claims.

1. A water-carrying household appliance, in particular dishwasher or washing machine, comprising
a tub in which items to be cleaned can be arranged for cleaning,
a detergent unit with a detergent reservoir and a detergent supply unit for supplying detergent from the detergent reservoir into the tub,
wherein the detergent reservoir is configured to receive detergent in a form of a solid body,
wherein the detergent supply unit comprises a separating device for partially separating detergent from the solid-shaped detergent arranged in the detergent reservoir,
wherein the detergent reservoir is configured to hold detergent for at least two cleaning operations.

2. The water-carrying household appliance according to claim 1, wherein the separating device is configured to separate detergent by means of a machining process, in particular by means of grating, planing, shearing or cutting,
in particular wherein
the detergent can be moved along the separating device in the detergent reservoir, or
the separating device can be moved along the detergent by means of a linear movement or by means of a rotational movement.

3. The water-carrying household appliance according to claim 1, wherein the detergent supply unit is configured to convey the separated detergent into the tub by means of process water.

4. The water-carrying household appliance according to claim 1, wherein the detergent supply unit is configured, in particular by means of a spring force, a screw movement, a linear motor or by means of a rotary wheel, to feed the detergent in the detergent reservoir to the separating device.

5. The water-carrying household appliance according to claim 1, wherein the separating device is configured to seal the detergent reservoir in a vapor-tight manner with respect to the tub.

6. The water-carrying household appliance according to claim 1, wherein the detergent reservoir is configured to accommodate a single, in particular rod-shaped or tabular detergent strand, in particular wherein the detergent strand has a length which is at least three times as great as its smallest width.

7. The water-carrying household appliance according to claim 1, wherein the detergent reservoir is configured to hold a stack of detergent tablets, and the separating device is configured to convey detergent tablets individually from the stack into the tub, in particular to separate them from the stack by means of a pushing movement.

8. The water-carrying household appliance according to claim 1, wherein the detergent reservoir is configured to hold a plurality of detergent tablets which are packed in a common packaging, in particular plastic packaging.

9. The water-carrying household appliance according to claim 8, wherein the separating device is configured to separate the detergent tablets individually from the packaging, in particular to press out of the packaging, or to cut out or cut off the detergent tablets together with the packaging.

10. The water-carrying household appliance according to claim 8, wherein the packaging has a plurality of chambers which are sealed off from one another in a vapor-tight manner, wherein one of the plurality of detergent tablets is arranged in each chamber.

11. The water-carrying household appliance according to claim 8, wherein the packaging is water-soluble or vapor-tight.

12. The water-carrying household appliance to claim 7, wherein the separating device is configured to dose at least two detergent tablets into the tub during a single cleaning operation.

13. The water-carrying household appliance according to claim 1, wherein the detergent supply unit is configured to seal the detergent reservoir in a vapor-tight manner with respect to the tub.

14. The water-carrying household appliance according to claim 1, wherein the detergent supply unit, during a transport of the separated, individual detergent tablet, transports the detergent tablet upwards at least in sections in order to reduce or prevent a transfer of vapor from the tub to the detergent reservoir.

15. The water-carrying household appliance according to claim 1, wherein the detergent supply unit comprises a siphon, a sluice system, a sealing slide, an iris diaphragm or a silicone seal, for preventing or reducing a transfer of vapor from the tub to the detergent reservoir.
